(19) United States
(12) Patent Application Publication
(10) Pub. No.: US 2014/0317118 A1
(43) Pub. Date: Oct. 23, 2014

(54) CONTEXT AWARE DYNAMIC SENTIMENT ANALYSIS

(71) Applicant: INTERNATIONAL BUSINESS MACHINES CORPORATION, Armonk, NY (US)

(72) Inventors: Shenghua Bao, Beijing (CN); David L. Cohn, Dobbs Ferry, NY (US); Yu Deng, Yorktown Heights, NY (US); HongLei Guo, Beijing (CN); Qi Hu, Beijing (CN); Richard B. Hull, Chatham, NJ (US); Roman Vaculin, Bronxville, NY (US)

(73) Assignee: International Business Machines Corporation, Armonk, NY (US)

(21) Appl. No.: 13/865,530

(22) Filed: Apr. 18, 2013

(51) Int. Cl. G06F 17/30

(52) U.S. Cl. CPC G06F 17/30598
USPC 707/738; 707/736

(57) ABSTRACT

A system and method to perform context aware sentiment analysis on a project that includes two or more aspects are described. The method includes identifying one or more inputs related to the project. The method also includes decomposing each of the one or more inputs, based on a content of the one or more comments, into at least one of the two or more aspects to generate one or more comment-aspect sets, each of the two or more aspects representing a context within the project, extracting opinions from each of the comment-aspect sets, and generating a disruptive argument based on the opinions.

### BACKGROUND

The present invention relates to a workflow process, and more specifically, to a workflow process incorporating sentiment analysis.

In a workflow process for a project that involves decision makers taking the opinions of the public or other groups into consideration, the ability to accurately know and use those opinions becomes important. For example, when a local government is working through the process of proposing a new construction project, public opinion must be considered for many aspects of the project such as location, scope and cost, time frame, etc. As one illustration, developers in a town originally propose building a large supermarket in a shopping center. Based on concerns over increased traffic, the public opposes the proposal. The developers then decide to build a movie theater instead. A face-to-face meeting with town representatives elicits a negative reaction, but after the developers publish an online article about the proposal and the decreased traffic during times of greatest concern, public sentiment indicates approval for the proposal. Without a tool to analyze the sentiments expressed in comments to the online article, the developers may not quickly and easily understand the public opinion. One way that public opinion is currently tracked is manually by conducting surveys or reading comments to articles or op-eds, for example. Once opinion sources are identified, sentiment analysis may be done on the opinions using current sentiment analysis software.

### SUMMARY

According to one embodiment of the present invention, a method of performing context aware sentiment analysis on a project that includes two or more aspects includes identifying, using a processor, one or more inputs related to the project; decomposing, using the processor, each of the one or more inputs, based on a content of the one or more inputs, into at least one of the two or more aspects to generate one or more comment-aspect sets, each of the two or more aspects representing a context within the project; extracting opinions from each of the comment-aspect sets; and generating a disruptive argument based on the opinions.

According to another embodiment of the invention, a system to perform context aware sentiment analysis on a project that includes two or more aspects includes an input interface to receive one or more inputs related to the project and instructions from a user, the instructions controlling a processor; the processor configured to decompose each of the one or more inputs, based on a content of the one or more inputs, into at least one of the two or more aspects to generate one or more comment-aspect sets, each of the two or more aspects representing a context within the project and perform sentiment analysis on each of the two or more aspects based on the one or more comment-aspect sets to perform sentiment analysis over time; and an output device configured to output one or more suggested actions generated by the processor to the user, the one or more suggested actions being identified by the processor as relating to a sentiment effector according to the sentiment analysis over time.

According to yet another embodiment of the invention, a computer program product for performing context aware sentiment analysis on a project that includes tow or more aspects comprises a computer readable storage medium having program code embodied therewith, the program code readable and executable by a processor to perform a method. The method includes identifying, by the processor, one or more inputs related to the project; decomposing, by the processor, each of the one or more inputs, based on a content of the one or more inputs, into at least one of the two or more aspects to generate one or more comment-aspect sets, each of the two or more aspects representing a context within the project; extracting, by the processor, opinions from each of the comment-aspect sets; and generating, by the processor, a disruptive argument based on the opinions.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a flow diagram of a method of performing context aware sentiment analysis on a project according to an embodiment of the invention;

FIG. 2 details the process of decomposing each input into aspects of the project according to an embodiment of the invention;

FIG. 3 details argument extraction according to an embodiment of the invention;

FIG. 4 exemplifies some of the processes discussed with reference to FIG. 2;

FIG. 5 illustrates a matrix based model according to embodiments of the invention; and

FIG. 6 is a block diagram of a system to perform context aware sentiment analysis on a project according to an embodiment of the invention.

### DETAILED DESCRIPTION

As noted above, opinion analysis can be important in certain workflows. The notion of sentiment (e.g., public sentiment for a particular project) is dynamic and changes throughout the decision making process. The sentiment may also be influenced by actions taken by the decision makers. Many people may express both opinions (sentiment) and concerns in a comment. By tracking the sentiment over time and by identifying the areas of concern and addressing them, decision makers may be able to sway public opinion regarding the project. Current processes for identifying and analyzing opinions may be at a document level and may be directed to a particular product or its features. Current processes may also require manual intervention in the identification and in the analysis. Additionally, while sentiment analysis software may be used to analyze identified opinions, such document-level analysis may not be helpful in analyzing comments that address multiple aspects of the projects (i.e., express multiple nuanced opinions). Embodiments of the system and method described herein track sentiment over time (dynamic sentiment analysis). Embodiments of the invention also decompose a comment to identify different aspects of a project that may be addressed by the single comment. This decomposition facilitates context aware sentiment analysis or analysis specific to each aspect of the project that is discussed. Further, the embodiments detailed herein capture suggestions embedded within comments and can provide suggestions developed in multiple ways (e.g., through comments, via historical information regarding similar situations) to decision makers. The automated decomposition and analysis described with respect to embodiments of the invention facilitates handling of a larger set of potential opinions than those found manually. Embodiments of the invention also relate to tracking the influence of actions taken by the decision makers or other events on sentiment, thereby facilitating a process of shaping opinions.

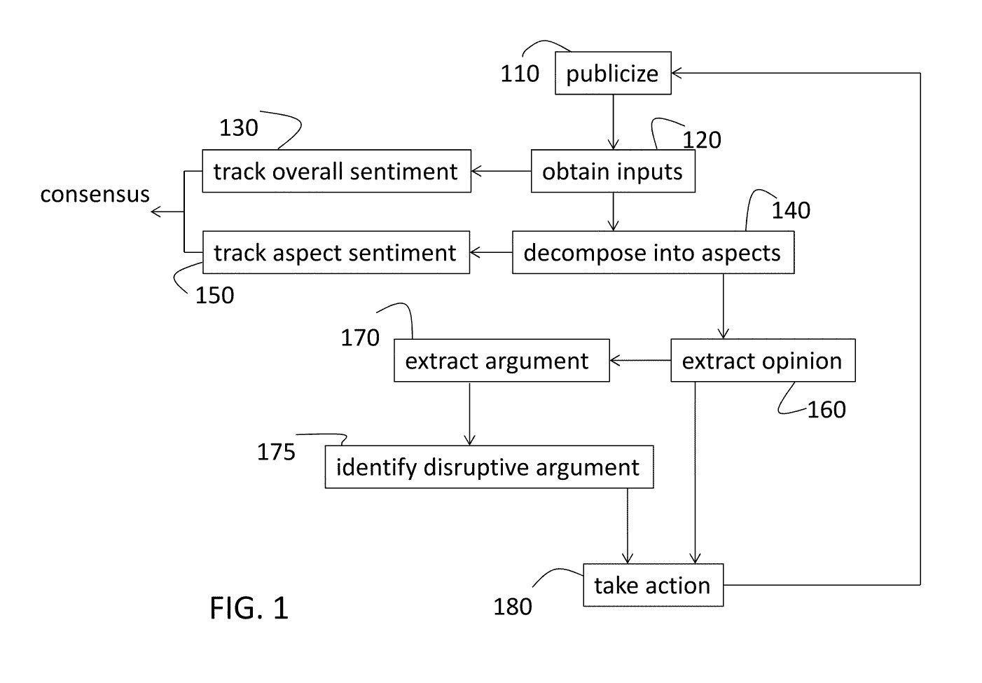

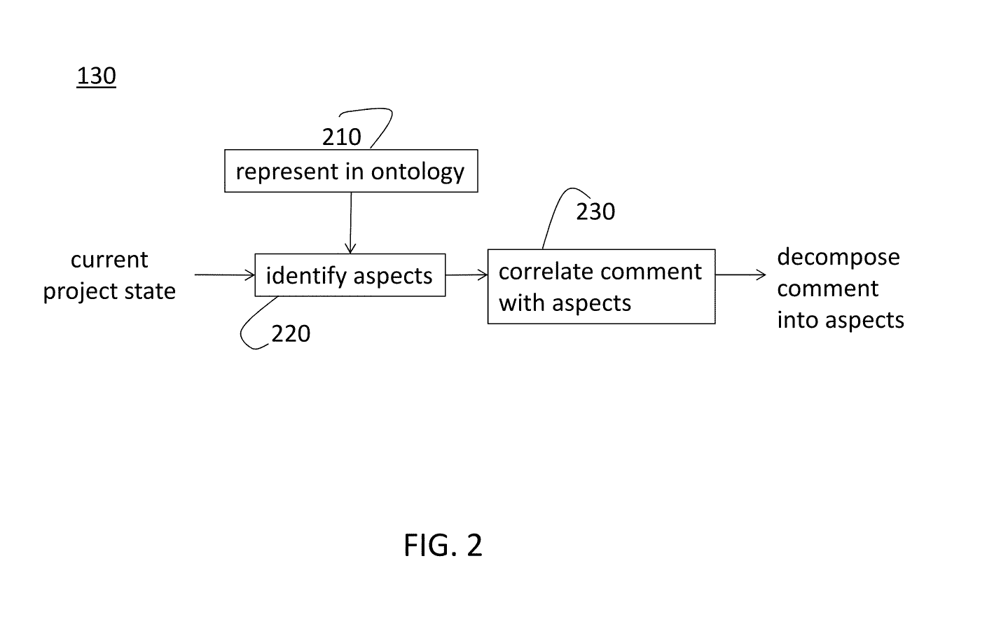

FIG. 1 is a flow diagram of a method of performing context aware sentiment analysis on a project according to an embodiment of the invention. The method may be implemented at different stages of the project as needed. For example, the method may be implemented in the planning stage but may then be repeated during the implementation, based on an unforeseen condition, for example. At block 110, publicizing includes publicizing a project, process, or process activity and may include actively seeking comments (e.g., conducting surveys) or disseminating information and searching different media (e.g., social network sites, newspaper op-eds) for comments. Publicizing the project may be considered as solicitation of inputs to the sentiment analysis. Obtaining inputs at block 120 may include obtaining comments to online articles, online forums, and other public discussions, blogs, and micro-blogs, for example. The method includes tracking overall sentiment at block 130 based on the inputs. Obtaining the inputs at block 120 may include using text-mining software on various sources such as comments to online articles related to the project or project stage and social networking sites. Decomposing comments into aspects (block 140) of the project or project stage (process or process activity) may include aspects such as location, scope and cost, time frame, and traffic, for example. This is discussed further with reference to FIG. 2. The subsequent sentiment analysis is referred to as context aware because each comment is first decomposed into each of the aspects of interest at block 140. The method includes tracking aspect sentiment (sentiment narrowed to a particular aspect) at block 150. As shown in FIG. 1, overall sentiment (tracked at block 130), aspect-specific sentiment (tracked at block 150), or both may be used to determine when consensus has been reached. As the discussion below clarifies, determining (and tracking) aspect-specific sentiment (at block 150) relies on opinion analysis (at block 160).

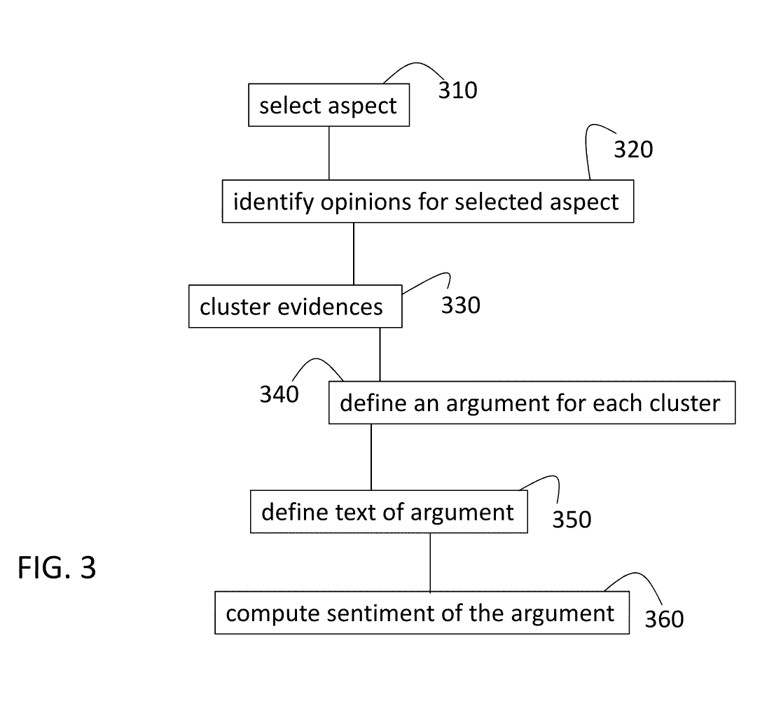

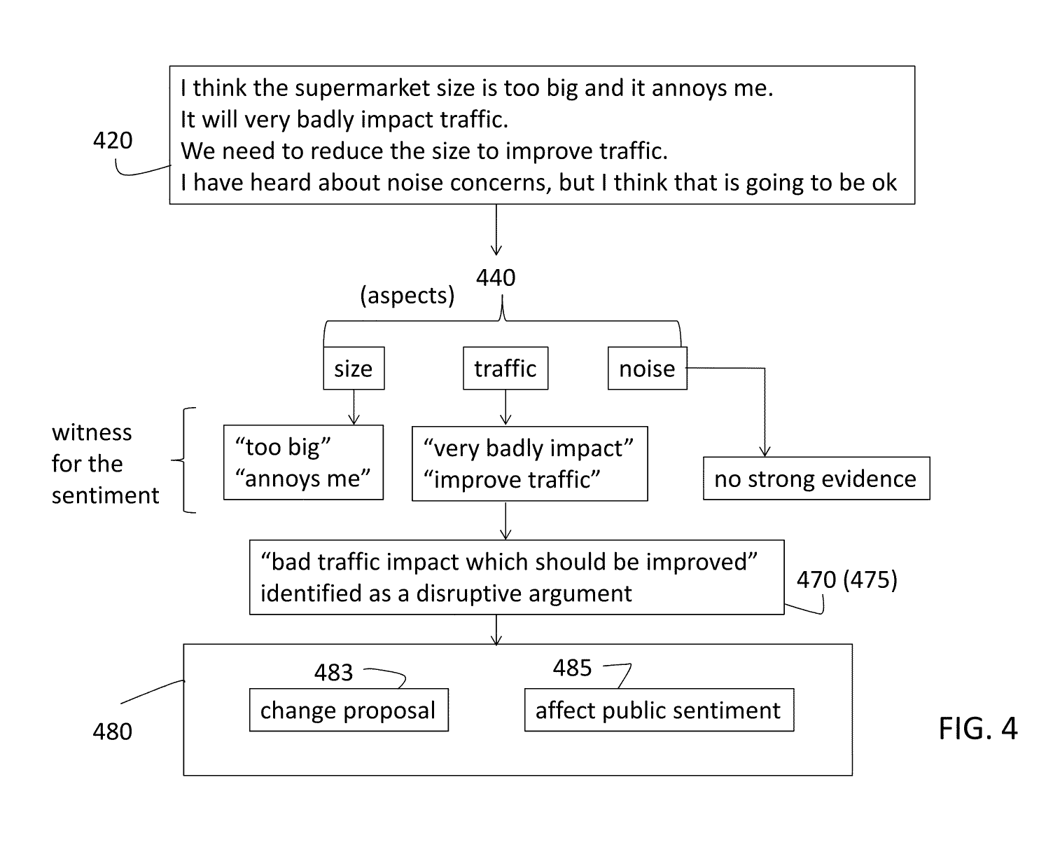

Not only is the sentiment analysis context aware such that sentiments expressed about different aspects may be understood and treated separately, but also, because of the increased granularity in the analysis, suggestions and concerns may be identified along with opinions. At block 160, extracting an opinion related to a particular aspect may include representing the opinion as a tuple of the following form (aspect, evidence (e.g., text snippet), sentiment, witness for the sentiment), with the opinion related to a particular aspect (e.g., location). Evidence represents the content of the opinion, which may be represented as a text snippet. The sentiment may be a measure of whether the opinion is perceived as being positive, negative, or in some other way. The sentiment may be represented as a numerical value. For example a positive sentiment may be represented by a +1, a negative sentiment by a −1, and a neutral sentiment as 0. Additionally granularity may be included, as well. For example, two different negative sentiments may be represented by −1 and −0.5 based on the strength of the witness for the sentiment. The witness for the sentiment captures why the opinion has a particular sentiment. That is, the witness for the sentiment may be the particular language that leads to a perception of a positive opinion or negative opinion. Opinion extraction is exemplified with reference to FIG. 4. At block 170, extracting an argument or concern may include identifying aspects for which more associated opinions are similar. That is, when one particular aspect (e.g., cost) has more similar opinions (e.g., negative opinions with similar evidence), the opinions may be clustered and indicate an argument or concern. Argument extraction is detailed with reference to FIG. 3 and also exemplified with reference to FIG. 4. At block 175, identifying a disruptive argument involves identifying an argument or concern (or aspect) that has a potential to sway public sentiment. The opinions and arguments, especially the disruptive argument, may influence the decision maker taking action (block 180) in an attempt to impact or change public sentiment. The process leading to decision makers taking action is further discussed with reference to FIG. 4. Thus, taking action (block 180) may be followed by another cycle of publicize and analyzing inputs. The cycles of taking action and analyzing sentiment may continue until some consensus is reached.

FIG. 2 details the process of decomposing each input into aspects of the project according to an embodiment of the invention. A project comprises multiple processes, each of which corresponds to an activity. Each process, which is a sequence of stages, includes multiple aspects. For example, a development project for a shopping center may include a traffic aspect. Such domain information about the process and the associated aspects is represented in an ontology (210). Using the ontology results in identifying one or more relevant aspects (220) of the project within the comments obtained at block 120 (FIG. 1). The ontology is a structural framework for organizing information or, in the present embodiment, for organizing aspects of the project. Correlating a comment (obtained as input at block 120, FIG. 1) with one or more of the identified aspects (block 230) results in a decomposition of the comment into each of the aspects that it addresses. The correlation of the comment with the identified aspects can be thought to frame the comment in the proper context within the project. That is, a comment (obtained as input at block 120, FIG. 1) may be broken down into comment-aspect sets that are snippets of the comment associated with the aspect they reference. Accordingly, the subsequent sentiment analysis (at block 140) is a context aware sentiment analysis.

FIG. 3 details argument generation (block 170, FIG. 1) according to an embodiment of the invention. As noted above, input (text) is obtained (block 120, Figure) and decomposed into aspects at block 140 (FIG. 1). The comment-aspect sets each have one or more opinions extracted at block 160 (FIG. 1). For a given aspect, selected at block 310, the opinions associated with that aspect (obtained from the comment-aspect sets) are identified at block 320. At block 330, evidence (text snippets) for opinions relating to the same aspect is clustered. That is, evidence that may be articulated similarly may be clustered. At block 340, defining an argument for each cluster may include identifying or generating text for each argument as the summary of evidence comprised by the cluster at block 350. Sentiment may then be computed (block 360) at the argument level rather than at an aspect level.

FIG. 4 exemplifies some of the processes discussed with reference to FIG. 2. Block 420 shows exemplary inputs. These inputs are decomposed (440) into exemplary aspects of size, traffic, and noise. From the exemplary inputs, exemplary witnesses for the sentiment are obtained for each aspect to extract opinions (block 160, FIG. 1). As shown, the text snippets “too big” and “annoys me” relate to the size aspect. The text snippets “very badly impact” and “improve traffic” relate to the traffic aspect, and no strong evidence is present in the input for the noise aspect. When opinions are clustered and arguments are identified (blocks 330 and 340, FIG. 3), one of the clusters, relating to the traffic aspect, may be summarized as “bad traffic impact which should be improved.” This summary defines the argument related to the traffic aspect. If several other opinions related to the traffic aspect and were clustered with the above examples or if some other pre-defined criteria were met (e.g., sentiment associated with traffic opinion cluster is most negative), then the disruptive argument (aspect) identified at blocks 470 and 475, respectively, may be “bad traffic impact which should be improved.” At block 480, an action may be undertaken by the decision maker. Two types of processes may be undertaken based on the sentiment determined through the analysis of inputs. The decision maker may change the proposal (483). For example, in the exemplary case in which “bad traffic impact which should be improved” is identified as a disruptive argument, the decision maker may change at least a portion of the previous proposal to address the traffic aspect and try to change overall sentiment. Alternately, the decision maker may take an action to affect public sentiment regarding the proposal (485). As part of block 480, the system that performs sentiment analysis may mine historical data to identify types of events that may be helpful with regard to the type of proposal and present suggestions for actions to the decision maker. Various alternative methods may be applied to identify possible actions. In some embodiments, identifying possible actions by the decision maker (generating suggestions) may be fully automated and may be performed by extracting information to identify action suggestion from comments. Crowdsourcing may be used to solicit suggestions, as well. The system may help the decision maker to identify the best action from the possible actions. Depending on the context, different criteria may be used: for example, according to one embodiment, an action may be selected based on maximizing the projected overall sentiment change, or on affecting sentiment change with respect to the disruptive argument(s).

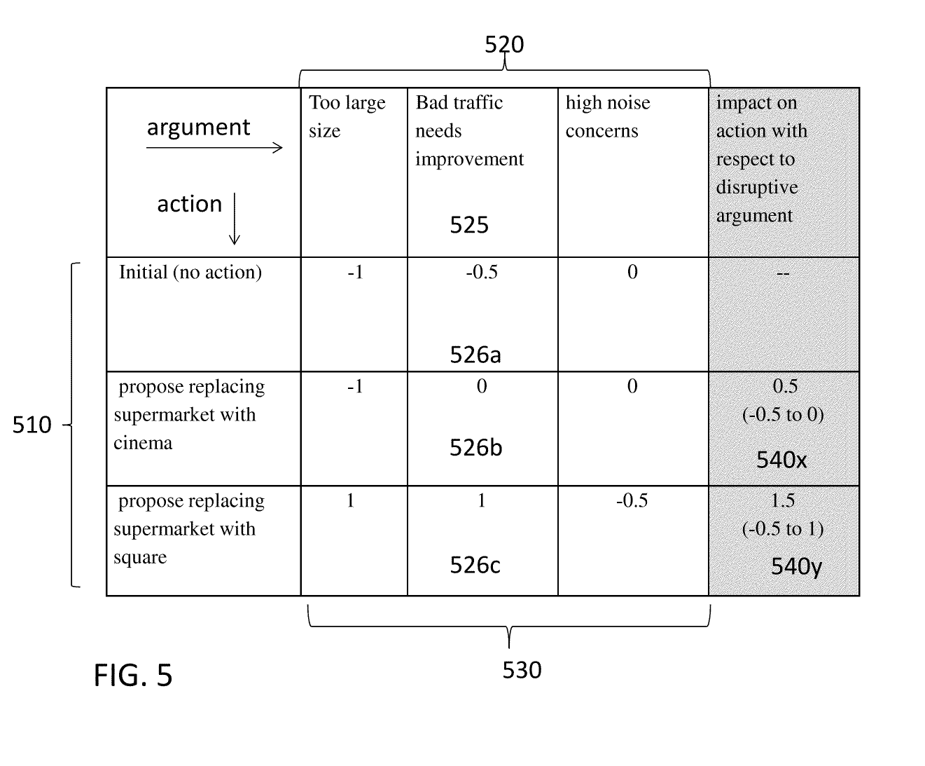

FIG. 5 illustrates a matrix based model according to embodiments of the invention. The matrix may facilitate several processes. For example, the matrix may facilitate tracking sentiment and aspect specific sentiment (blocks 130, 150, FIG. 1). The matrix may also facilitate identification of the disruptive argument (block 175, FIG. 1) to determine the action that should be taken (block 180, FIG. 1) to address the disruptive argument. Each row 510 of the matrix represents an action that could be taken to impact sentiment of different aspects. Arguments identified for each of the aspects are shown as the column headings 520. The sentiment determined for each argument at each point in time is indicated by a score 530. For example, initially, when the supermarket is proposed, the “bad traffic needs improvement” argument, which is identified as the disruptive argument 525, has a sentiment score of −0.5 (526a). When an action is taken proposing to replace the supermarket with a cinema, that disruptive argument 525 has a new score of 0 (526b). The change from −0.5 (526a) to 0 (526b) is reflected in the last column (540x), which notes the impact of each action on the disruptive argument 525. When another action is taken proposing to replace the supermarket with a square, the disruptive argument 525 has a new score of 1 (526c). The change from −0.5 (526a) to 1 (526c) is reflected in the last column (540y). Based on the scores in this example (the dynamic tracking of sentiment following each action), the suggested action would be to replace the supermarket proposal with a square because the impact (comparing 540y to 540x) is maximized for this proposal. In this example, the action (proposing to change the supermarket to a square) may be viewed as a key driver or sentiment driver. Generally, an event, argument, or disruptive argument that has a relatively large effect on sentiment (aspect-specific sentiment or overall sentiment) may be viewed as a sentiment effector.

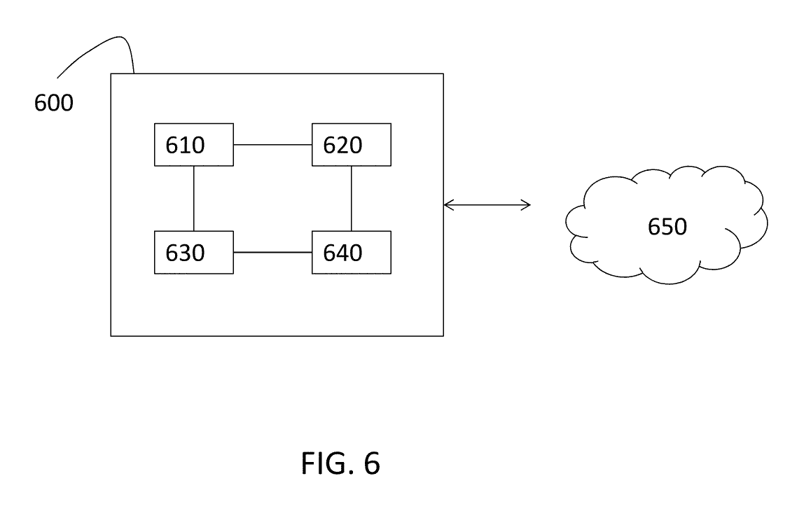

FIG. 6 is a block diagram of a system 600 to perform sentiment analysis according to an embodiment of the invention. The system 600 includes one or more processors 610, one or more memory devices 620, an input interface 630, and an output interface 640. The system 600 implements one or more blocks of the context aware sentiment analysis process according to embodiments discussed above. The one or more memory devices 620 may store program code, processed by the one or more processors 610 to implement the context aware sentiment analysis according to embodiments discussed above. For example, the system 600 may implement a data mining process to identify inputs (comments) related to the project. The system 600 may perform one or more aspects of the project workflow, as well. The system 600 communicates over one or more networks 650 to obtain project processes and/or to obtain inputs. The input interface 630 facilitates input from the decision maker regarding several aspects of the process. For example, the decision maker or other user may specify sources for generating suggestions (see e.g., block 485, FIG. 4). For example, rather than suggesting a change in the project plan based on negative sentiment, a suggestion for how to sway sentiment (e.g., hosting a town hall meeting to address concerns related to an aspect of the project) may be generated based on historic examples. The decision maker or other user may also specify how identifying the disruptive argument (block 185) is done. For example, it may be specified through the user interface 630 that the similar opinions associated with the most inputs should be identified as arguments, and the disruptive argument may be identified as the argument associated with the most negative sentiment. Alternative ways of identifying disruptive arguments may include techniques based on detection of dramatic changes of sentiment over time, or based on the highest expected impact. The output device 640 may be a display device that presents suggestions and other information. The output device 640 may also output information, over a network 450 according to some embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method of performing context aware sentiment analysis on a project that includes two or more aspects, the method comprising:
identifying, using a processor, one or more inputs related to the project;
decomposing, using the processor, each of the one or more inputs, based on a content of the one or more inputs, into at least one of the two or more aspects to generate one or more comment-aspect sets, each of the two or more aspects representing a context within the project;
extracting opinions from each of the comment-aspect sets; and
generating a disruptive argument based on the opinions.

2. The method according to claim 1, wherein the extracting the opinions includes expressing each opinion as a tuple including a text snippet representing the opinion and a sentiment expressed by the opinion.

3. The method according to claim 1, further comprising clustering the opinions according to a similarity in sentiment and generating arguments, each argument being represented by a summary of clustered opinions,

4. The method according to claim 3, wherein the generating the disruptive argument is based on selecting one of the arguments according to a user specified criteria.

5. The method according to claim 3, further comprising identifying a sentiment associated with each argument, wherein each sentiment is represented by a numerical score.

6. The method according to claim 5, further comprising tracking the sentiment associated with each argument to suggest an action for addressing the disruptive argument.

7. The method according to claim 6, further comprising tracking a change in the sentiment associated with each argument and tracking overall sentiment associated with the project to suggest an action.

8. The method according to claim 6, wherein the action is one of a plurality of suggested actions.

9. The method according to claim 8, wherein the plurality of suggested actions are based on mining of historical data.

10. The method according to claim 8, wherein the plurality of suggested actions are based on crowdsourcing

11. The method according to claim 8, wherein the action is a recommended action among the plurality of suggested action based on a projected maximum change with respect to an overall sentiment or the sentiment associated with the disruptive argument.

12-20. (canceled)
